(19) United States
(12) Patent Application Publication
(10) Pub. No.: US 2009/0128708 A1
(43) Pub. Date: May 21, 2009

(54) MONITORING UNIT FOR USE IN A SYSTEM FOR MULTIMEDIA CONTENT DISTRIBUTION

(75) Inventors: James Huffman, Kansas City, MO (US); Darren Kaufman, Olathe, MO (US); Douglas Medina, Grain Valley, MO (US)

Correspondence Address: AT&T Legal Department - JW;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 11/943,877

(22) Filed: Nov. 21, 2007

(51) Int. Cl. H04N 5/00; H04N 7/26

(52) U.S. Cl. 348/705; 375/240.01; 348/E05.001; 375/E07.026

(57) ABSTRACT

A disclosed multimedia signal monitoring unit includes a chassis and, within the chassis, a processor, a multimedia signal receiver for receiving an encoded multimedia stream, and a plurality of decoders. Each of the decoders can decode an encoded multimedia signal, where at least two of the plurality of decoders is operable to decode the multimedia signal using different decoding algorithms. The decoder includes a switch under control of the processor. In some embodiments, the switch is configured to connect the receiver to a selected one of the decoders. A user input interface is connected to the microprocessor and is operable to manually operate the switch. Each decoder may be attached to a corresponding circuit board. Each of the circuit boards is received within a corresponding slot defined within the chassis. The circuit boards may be swapped among the slots. Each decoder may be operable to decode a multimedia signal modulated using 8-level vestigial sideband modulation.

### BACKGROUND

1. Field of the Disclosure

The disclosed subject matter relates generally to instrumentation for monitoring the transmission quality of digital signals and, more particularly, digital multimedia content signals.

2. Description of the Related Art

Advanced Television Systems Committee (ATSC) standards define a digital standard for over the air TV reception in the United States. The development of the standard required a transmission (encoding) specification and a receiving (decoding) specification. In order to get the standard developed, the transmission specification, generally referred to as 8-level vestigial sideband (8VSB) modulation, was finalized first. After the transmission standard was established, the decoding side of the process started to evolve and so did the variety of decoder chip sets used in ATSC tuners. Currently there are five different generations of ATSC decoder chip sets. A consumer or commercial receiver may use any one of the five generations of chip sets.

### BRIEF DESCRIPTION OF THE DRAWINGS

FIG. 1 is a block diagram of selected elements of an embodiment of a signal transmission system;

FIG. 2 is a block diagram illustrating additional detail of the transmission system of FIG. 1;

FIG. 3 is a block diagram illustrating additional detail of the transmission system of FIG. 1;

FIG. 4 illustrates a monitoring unit according to one embodiment; and

FIG. 5 is a block diagram of selected elements of an embodiment of a monitoring unit.

### DESCRIPTION OF THE EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 102-1 refers to an instance of a widget class, which may be referred to collectively as widgets 102 and any one of which may be referred to generically as a widget 102.

In one aspect, a monitoring unit for use in monitoring and/or testing digital multimedia content signals is disclosed. The disclosed monitoring unit may include locally or remotely selectable functionality for decoding a multimedia content signal using any of a plurality of signal decoding algorithms. In some embodiments, the monitoring unit includes multiple chip sets where each chip set corresponds to a respective decoding algorithm or a respective version of a particular decoding algorithm and selection of the appropriate decoding algorithm is achieved by selection of the applicable chip set. In these embodiments, the selectable functionality allows a technician to analyze a signal using the same decoding algorithm as a device that is experiencing a problem to create a known baseline from which to troubleshoot. Having the ability to emulate a device beneficially facilitates the process of determining the device, the incoming signal, or both as the source of a problem. The ability to employ different versions of a decoding algorithm would also allow for making the wisest decision on equipment deployment by, for example, identifying geographic locations where older generation decoding algorithms may be adequate.

In another aspect, the disclosed monitoring unit includes an analysis module employing multiple algorithms for demodulating and analyzing a digital multimedia signal. The different algorithms may be selected, either remotely or locally, so that, at any time, the monitoring unit is using one of a multiple of decoding algorithms. In some embodiments, different decoding algorithms employed by the analyzer are implemented with corresponding chip sets so that, for example, a first decoding algorithm is implemented in a first chip set, a second decoding algorithm is implemented in a second chip set and so forth. In some embodiments, the disclosed monitoring unit may support two or more different generations or revisions of a demodulation specification. In embodiments suitable for use in conjunction with the terrestrial broadcasting of ATSC compliant multimedia signals, for example, the disclosed monitoring unit may include two or more selectable chip sets where each chip set implements an algorithm for demodulating an 8VSB modulated signal.

In some embodiments, the disclosed monitoring unit as implemented includes a chassis configured to receive two or more swappable decoding boards, where each decoding board includes a chip set and software/firmware to support a particular decoding algorithm, such as a particular revision of an 8VSB decoding algorithm. The chassis might further include a reception port for receiving a signal and a switch operable to connect the reception port to any of the selectable decoding boards currently installed in the chassis. Each decoding board may generate a decoded signal as an output and provide the decoded signal to an analysis module for determining one or more characteristics or parameters for the decoded signal. The chassis may also include a communications link. The communications link may communicate with a monitoring station. The communications link may, for example, communicate the decoding signal to the monitoring station or communicate a signal indicative of the output of the analysis of the demodulated signal. Thus, for example, the disclosed monitoring unit may decode a signal according to a selectable decoding algorithm and transmit the decoded signal to a monitoring station for analysis. In other embodiments, the decoded signal is provided to an analysis module within the monitoring unit for further analysis.

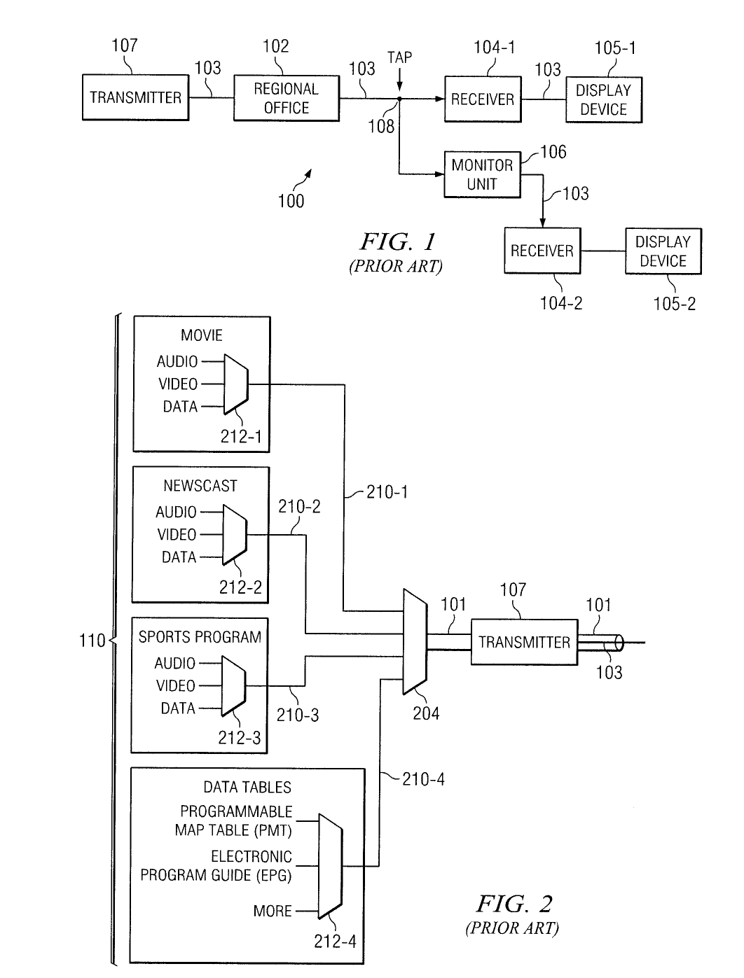

Before describing details of any particular embodiment, a description of an exemplary environment in which disclosed monitoring units may be used is presented. Referring to FIG. 1, selected elements of a multimedia distribution system 100 are depicted. As depicted in FIG. 1, a regional office 102 of multimedia distribution system 100 receives a multimedia signal 103 from transmitter 107.

Transmitter 107 may be a broadcast transmission tower or the like and multimedia signal 103 may be a broadcast quality, Advanced Television Systems Committee (ATSC) compliant multimedia signal. In other implementations, transmitter 107 may include elements or aspects of a national office, also sometimes referred to as a national headend, that delivers multimedia content to one or more regional offices including the depicted regional office 102. For implementations in which transmitter 107 represents a national headend, multimedia signal 103 may be transmitted over a fiber optic backbone or other suitable high bandwidth medium to regional office 102.

Although FIG. 1 depicts a single multimedia signal 103, regional office 102 may receive multiple multimedia signals 103 including one or more broadcast multimedia signals and one or more multimedia signals delivered via a backbone connection to the national headend. In this manner, regional office 102 may combine and deliver, to its subscribers, national“feeds” as well as regionally or locally broadcasted content. Regional office 102 may also insert content such as regional or local advertising, insert metadata such as electronic programming guide information, and encode or format multimedia signals for transmission to subscribers.

As depicted in FIG. 1, regional office 102 transmits multimedia signal 103 to one or more multimedia signal receivers 104. To the extent that multimedia signal 103 is compressed, encrypted, and/or otherwise encoded, multimedia signal receivers 104 are operable to decode multimedia signal 103 and display the decoded signal on a display device 105. Multimedia signal receiver 104 and display device 105 may be implemented as a set top box connected to a television set or a set top box connected to a display monitor. In implementations that do not employ a set top box, multimedia signal receiver 104 and display device 105 may both be part of a television.

In some embodiments, multimedia signal 103 as received by regional office 102 corresponds to a single item of multimedia content, e.g., a single show or a single video-on-demand title. In these embodiments, regional office 102 may aggregate a number of such signals and transmit multimedia signal 103 as part of a composite multimedia signal (not depicted explicitly) that includes multiple shows and/or movies. In such cases, receiver 104 may be responsible for selectively processing the desired multimedia signal by filtering the composite multimedia signal as transmitted by regional office 102. In a coaxial based system, for example, in which regional office 102 transmits all or substantially all available channels of multimedia content to the end user simultaneously, the desired multimedia signal 103 may correspond to particular frequency band and receiver 104 may be operable as a tuner that selects multimedia signal 103 from the composite signal.

Multimedia signal 103 may be an encoded signal in which the multimedia content is formatted according to a predetermined protocol or specification. In some embodiments, for example, multimedia content stream may be encoded according to a pervasive encoding protocol such as MPEG 2 or the like. In some embodiments, multimedia signal 103 may be broadcast transmitted to receiver 104 from regional office 102 or directly from the broadcaster (not depicted). In other embodiments, regional office 102 delivers multimedia signal 103 to receiver(s) 104 over a wired access network, which may have a physical medium implemented with twisted copper cable, coaxial cable, fiber optic cable, any combination thereof, or a suitable alternative.

As shown in FIG. 1, a monitoring unit 106 is connected to or otherwise operable to communicate with a tap 108 in multimedia signal 103 so that the monitoring unit 106 receives the same or substantially the same multimedia signal 103 that receiver 104-1 receives. Monitoring unit 106 may also be configured to transmit multimedia signal 103 to receiver 104 for display on display device 105. In this configuration, monitoring unit 106 may perform some processing of the received multimedia signal 103. For example, if the multimedia signal 103 as received by monitoring unit 106 is a broadcast signal, monitoring unit 106 may demodulate and/or decode the multimedia signal so that the multimedia signal 103 as delivered to receiver 104-2 is demodulated and/or decoded. Although FIG. 1 depicts tap 108 as being located between regional office 102 and receiver(s) 104, the tap may also be located further“upstream” such as where multimedia signal 103 is received by regional office 102. In one such implementation, multimedia signal 103 is broadcast transmitted by transmitter 107 and the tap 108 is located at the input to regional office 107 so that monitoring unit 106 receives the broadcasted multimedia signal 103 and analyzes, processes, and/or transmits it on to receiver 104-2.

Referring now to FIG. 2, selected elements of multimedia distribution system 100 are depicted to illustrate the generation and transmission of a composite multimedia signal that includes one or more streams or channels of multimedia content, including the desired multimedia signal 103. As shown in FIG. 2, for example, the desired multimedia signal 103 is part of a composite multimedia signal 101 generated by a multiplexer 204. Multiplexer 204 receives multiple channels 210-1 through 210-4 of multimedia content. As depicted in FIG. 2, each channel 210 is generated by a corresponding multiplexer 212. Each channel 210 may include audio content, video content, and data content. FIG. 2 depicts a channel 210-1 containing movie content, a channel 210-2 containing news content, and a channel 210-3 containing sports content. In addition, multiplexer 204 receives channel 210-4 containing data table content such as an electronic programming guide information. Although the implementation depicted in FIG. 2 illustrates a composite multimedia signal 101 transmitted by transmitter 107, a regional office 102 (see FIG. 1) that receives composite multimedia signal 101 may transmit content from just a single channel to the subscriber. In an Internet Protocol Television (IPTV) environment, for example, the multimedia signal 103 transmitted by regional office 102 to any particular subscriber may include just a single channel 210 of content. The access network in these embodiments may be implemented with a physical medium such as twisted pair and/or fiber.

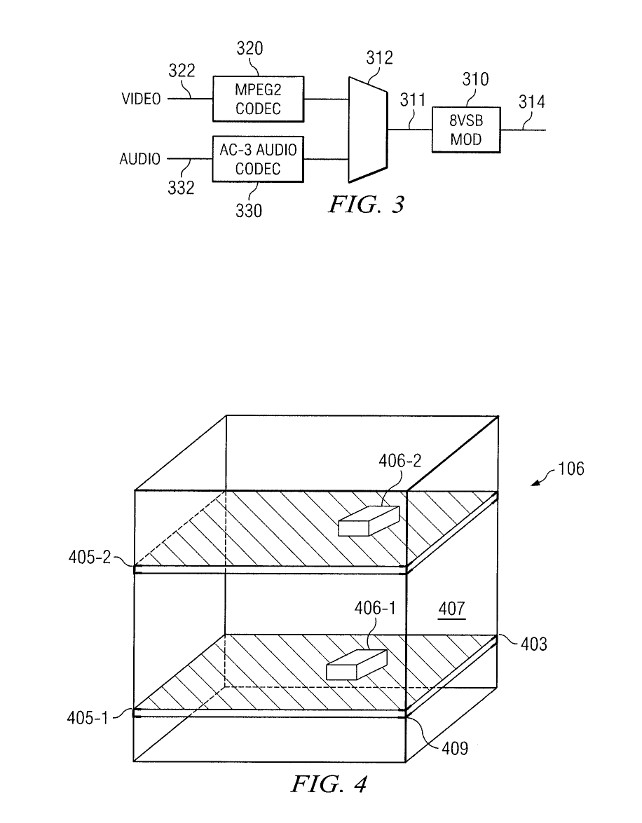

Referring to FIG. 3, selected elements of an embodiment of multimedia distribution system 100 emphasizing exemplary coding and modulation used to generate a single multimedia signal 103 are depicted. The depicted embodiment is suitable for use in an environment wherein multimedia signal 103 is an ATSC signal that is broadcast transmitted by a terrestrial transmitter. In this embodiment, a video source 322 is encoded by an MPEG-2 video encoding module 320 and an audio source 332 is encoded by an AC-3 audio encoding module 330. MPEG-2 video encoding and AC-3 audio encoding are both well known in the field of multimedia systems. The signals generated by modules 320 and 330 are multiplexed in multiplexer 312 to produce a transport stream 311. In some embodiments, transport stream includes a sequence of 188-byte packets that are compliant with the MPEG-2 transport stream specification. Transport stream 311 is then modulated by an 8VSB module 310 to produce modulated signal 314, which is suitable for transmission as multimedia signal 103. 8VSB module 310 implements 8-level Vestigial Sideband modulation, which is adapted for terrestrial broadcast of an ATSC compliant multimedia signal in the United States, Canada, and other countries.

Because each byte of multimedia signal 103 is important to both the identification of the proper channel selected by a user and the content to ultimately be displayed to the user, lost data, whether lost in transmission to receiver 104 or during delivery to transmitter 107, will degrade the signal delivered to the subscriber or other end user and the user may not be able to view selected content satisfactorily. Historically, an operator of a transmission system often became aware such errors were occurring only after an error or problem was reported by an end user, at which time the operator would initiate corrective action.

Monitoring unit 106 may monitor the transmission subsystem and the reception subsystem for a multimedia signal, since error can occur at either location. Monitoring unit 106 may monitor and diagnose errors resulting from the signal transmission or receiver equipment as well as errors resulting from geographical or environmental disturbances, including weather related disturbances. In order to monitor and diagnose errors, monitoring unit 106 may analyze either a real time or recorded broadcast channel to find a non-functioning channel, which may be one that plays no content, the wrong content, audio and video content out of synch, etc. To quantify the quality of an incoming signal, monitoring unit 106 may monitor parameters including packet error rate for decoding the signal into packets; the signal-to-noise ratio after equalization and phase correction, at the point where the signal goes into a decoder; and the tap coefficients and total tap energy from the equalization stage; and may analyze the syntax of the transport packets; the percentage of the transport stream used by various data types, channels, and elementary streams; and the accuracy, jitter, and transmission frequency of the Program Clock References.

FIG. 4 shows selected aspects of an embodiment of a multimedia signal monitoring unit. As shown, monitoring unit 106 includes a chassis 403 that contains two separate swappable circuit boards 405-1 and 405-2. The depicted chassis 403 has a generally boxed like shape, and may be fabricated from any suitable material including, for example, aluminum, steel, durable plastics, and the like. Preferably, chassis 403 as shown includes a removable panel 407 that, when removed, allows access to the internal components of monitoring unit 106 and, more specifically, access to circuit boards 405. Removable panel 407 may be attached to chassis 403 via screws, a hinge and lock mechanism, friction fit, or similar such mechanisms. Inside chassis 403, brackets 409 may be disposed to provide a mechanism for mounting and supporting the circuit boards 405. Brackets 409 may be fabricated of any one of several materials capable of being shaped into brackets and secured to chassis 403. As depicted, brackets 409 are disposed along the corners of chassis 403 using rivets, screws, adhesive, or the like. However, one skilled in the art will appreciate that brackets 409 may be disposed along the sides of chassis 403 on all four sides, on two sides, on two corners and a side, and so on, as long as circuit boards 405 can be held securely within chassis 403.

Circuit boards 405 are disposed within chassis 403, in parallel, and in such a manner as to be electrically isolated from one another, using brackets 409. Circuit boards 405 may be secured to brackets 409 using a friction fit, adhesive, screw means, or similar means. One skilled in the art will appreciate that depending upon the materials used to fabricate chassis 403, brackets 409, removable panel 407, and the attachment means for all of these, and whether chassis 409 is to be installed in an outdoor location, it may be necessary to electrically isolate circuit boards 405 using, for example, a resin coating.

In some embodiments, circuit boards 405 are operable as decoding boards capable of decoding encoded multimedia signals. In the depicted embodiment, for example, each circuit board 405 includes a corresponding chip set 406. Chip sets 406 may be implemented as single chip or multiple chip decoders that include hardware, firmware, and software to demodulate and otherwise decode multimedia signals. In other embodiments, the decoding functionality of chip sets 406 may be implemented entirely or primarily in software. In some embodiments, for example, chip sets 406 are operable to demodulate an MPEG-2 compliant multimedia stream that has been modulated using 8VSB modulation. In some embodiments, each chip set 406 supports or uses a corresponding demodulation algorithm. In embodiments of monitoring unit 106 dedicated to multimedia signals that are modulated using 8VSB modulation, each chip set 406 may correspond to a different revision of an 8VSB demodulation specification. More generally, each circuit board 405 in monitoring unit 106 may include a corresponding decoder unit operable to decode a multimedia signal.

Circuit boards 405 may be implemented using commercially distributed electronic components for analyzing signals. Examples of such circuit boards include the MPM 400 model of boards sold by Tektronix, Inc., and past and future generations of the same. When each circuit board 405 corresponds to a different decoding algorithm, monitoring unit 106 as shown achieves integration of several different generations of monitoring units, each employing different chipsets to demodulate digital signals, in one monitoring unit.

The general operation of monitoring unit 106 will now be described with reference to FIGS. 1, 3, and 4. A multimedia signal 103 is sent from transmitter 107 to regional office 102 of a content provider or service provider. Regional office 102 sends multimedia signal 103 to receivers 104, e.g. televisions, to be demodulated by the receiver units and converted to signals capable of being viewed by a user on display device 105. Monitoring unit 106 may be located within regional office 102. Monitoring unit 106 is shown as tapping into a multimedia signal 103 as transmitted from regional office 102. Monitoring unit 106 may also connect, wirelessly or otherwise, to a local or remote monitoring station via a communications link so as to enable monitoring unit 106 to upload data related to multimedia signal 103 to the monitoring station. If the monitoring station is notified of an error in multimedia signal 103 by monitoring unit 106, technicians are able to begin diagnosing and correcting the same.

Each circuit board 405 contained within the chassis 403 of monitoring unit 106 may directly tap into the multimedia signal output to the receivers 104, or may in the alternative be connected to another control circuit that further directs the signals incoming to and outgoing from monitoring unit 106.

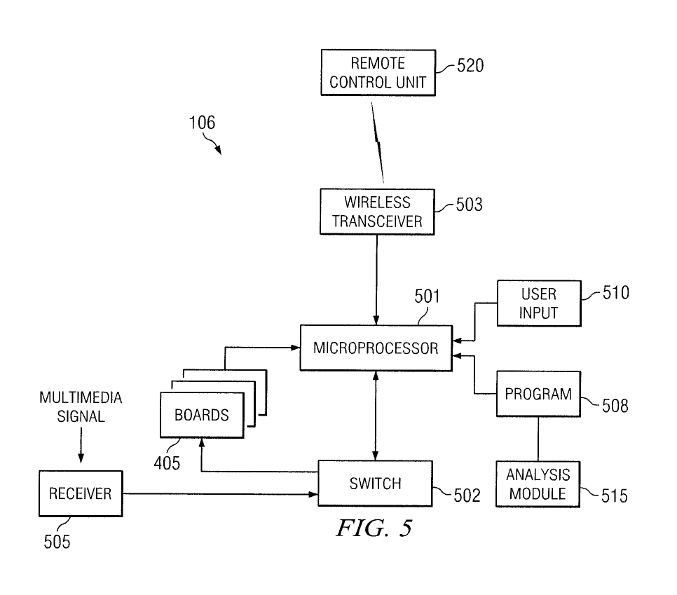

Referring now to FIG. 5, additional detail of an embodiment of monitoring unit 106 is depicted. As depicted in FIG. 5, monitoring unit 106 includes a microprocessor 501, a switch 502, a wireless transceiver 503, a multimedia signal receiver 505, a computer program 508, a user input interface 510, and a remote control unit 520. Computer program 508 represents computer readable storage medium on which are stored or in which are embedded computer executable instructions. For example, computer program 508 may include analysis module 515, which may include computer executable instructions stored in computer program 508 for use in analyzing the decoded multimedia stream from circuit boards 405. Analysis module 515 may determine characteristics of the stream including packet error rate for decoding the signal into packets, signal-to-noise ratio after equalization and phase correction, at the point where the signal goes into a decoder, and the tap coefficients and total tap energy from the equalization stage. Analysis module 515 may also analyze the syntax of the transport packets; the percentage of the transport stream used by various data types, channels, and elementary streams; and the accuracy, jitter, and transmission frequency of program clock references.

Multimedia signal receiver 505 is operable to receive a broadcast multimedia signal such as multimedia signal 103 (FIG. 1). In the depicted embodiment, multimedia signal receiver 505 connects to one of the multiple circuit boards 405 via switch 502, which is controlled by microprocessor 501. Each circuit board 405 may correspond to a different decoding and/or demodulation algorithm. Wireless transceiver 503 is operable to communicate with a remote location such as a monitoring station. Wireless transceiver 503 may receive a switching control command or signal from the remote location and provide the switch control command or signal to microprocessor 501. Microprocessor 501 may operate under a computer program 508 to use the switch control command or signal to control switch 502 to connect multimedia receiver 505 to a corresponding circuit board 405. In the depicted embodiment, circuit board 405 selected by switch 502 decodes and/or demodulates the incoming broadcast signal and provides an output to microprocessor 501. In some embodiments, the information output from circuit boards 405 may include the decoded multimedia stream itself and/or statistics related to the decoded multimedia stream including, as examples, error rate information, signal/noise data, and so forth.

For simplicity, the above description contemplates a monitoring unit 106 in which the circuit boards 405 are selected individually either manually such as by user input interface 510 or remotely by a user at the monitoring station. In other embodiments, microprocessor 501 may be operable to select the circuit board 405 automatically.

In use, monitoring unit 106 may be continuously monitoring outgoing television signals for multiple channels of content using multiple chip sets with different processing capabilities, i.e., it is demodulating and processing the data packets for each output channel using chipsets corresponding to multiple generations of receivers. To do this, a particular circuit board 405 is either automatically selected or selected by a user as described above. The circuit board then outputs appropriate monitoring or diagnostic signals to the station and the next circuit board is queried. When a new chipset is delivered to market, the operator removes the top portion of the monitoring unit and either expands the number of boards, or replaces a board already contained therein. The monitoring unit is then reset, i.e., the maximum number of circuit boards, time to query each board, etc., and the monitoring unit resumes monitoring the digital signal. In this way, monitoring unit 106 is capable of changing and expanding to test digital signals according to the capabilities of different generations of chipsets.

One skilled in the art will appreciate the monitoring units on the circuit boards as disclosed herein will retain much of their previous functionality and accordingly may also be used to analyze recorded signals or signals supplied by various receivers. Moreover, although the subject matter has been described with reference to a certain embodiment, this description is not meant to be construed in a limiting sense. On the contrary, various modifications of the disclosed embodiment will become apparent to those skilled in the art upon reference to the detailed description. It is therefore contemplated that the appended claims will cover such modifications, alternatives, and equivalents that fall within the spirit and the scope of the claimed subject matter. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A multimedia signal monitoring unit, comprising a chassis and within the chassis:
a processor;
a multimedia signal receiver for receiving an encoded multimedia stream;
a plurality of decoders, wherein at least two of the decoders are operable to decode the encoded multimedia stream using different decoding algorithms;
an analysis module to determine characteristics of decoded multimedia streams from the decoders; and
a switch under control of the processor, wherein the switch is configured to connect the receiver to a selected one of the decoders.

2. The monitoring unit of claim 1, further comprising a user input interface connected to the microprocessor and configured to operate the switch.

3. The monitoring unit of claim 1, wherein each decoder is attached to a corresponding circuit board.

4. The monitoring unit of claim 3, wherein each of the circuit boards is received within a corresponding slot defined within the chassis.

5. The monitoring unit of claim 4, wherein the circuit boards are swappable among the slots.

6. The monitoring unit of claim 1, wherein each decoder corresponds to a decoder operable to decode a multimedia stream modulated using 8-level vestigial sideband modulation.

7. The monitoring unit of claim 1, wherein at least one of the decoders generates an Advanced Television Systems Committee compliant signal.

8. A monitoring unit including a chassis that defines a set of printed circuit board slots, the monitoring unit comprising:
a receiver operable to receive a digital multimedia signal;
a plurality of decoding boards received in respective printed circuit board slots, wherein at least two of the decoding boards are operable to execute different decoding algorithms to decode an encoded multimedia signal; and
a switch operable to connect the multimedia signal to a particular one of the decoding boards.

9. The monitoring unit of claim 8, wherein the monitoring unit includes a user input interface that enables manual operation of the switch.

10. The monitoring unit of claim 8, wherein the monitoring unit includes a wireless transceiver operable to receive a switch control signal from a remote command unit, wherein the monitoring unit is operable to control the switch based on the switch control signal.

11. The monitoring unit of claim 8, wherein at least one of the decoding boards is operable to generate a decoded Advanced Television Systems Committee (ATSC) compliant signal.

12. The monitoring unit of claim 11, wherein a first decoding board is operable to generate a decoded ATSC compliant signal based on a first revision of a decoding algorithm and wherein a second decoding board is operable to generate a decoded ATSC compliant signal based on a second revision of the decoding algorithm.

13. The monitoring unit of claim 12, wherein the first decoding board includes a first revision of a chip set operable to perform the first revision of the decoding algorithm and wherein the second decoding board includes a second revision of a chip set operable to perform the second revision of the decoding algorithm.

14. The monitoring unit of claim 8, further comprising an analysis module operable to analyze the decoded multimedia streams produced by the encoding modules.

15. The monitoring unit of claim 14, wherein the analysis module is operable to determine an error rate associated with the decoded multimedia stream.

16. A monitoring unit, comprising
a chassis including slots for receiving a plurality of decoding boards;
a plurality of decoding boards received within respective slots;
a receiver operable to receive a broadcast transmitted digital television signal; and
a switch operable to select a decoding board from the plurality of decoding boards and connect the received signal to the selected decoding board for decoding.

17. The monitoring unit of claim 16, wherein the receiver is operable to receive an encoded MPEG-2 multimedia stream.

18. The monitoring unit of claim 16, wherein at least one of the decoding boards implements a demodulation for an 8VSB modulated signal.

19. The monitoring unit of claim 18, wherein at least two of the decoding boards implement a corresponding revision of a decoding algorithm.

20. The monitoring unit of claim 16, further comprising a wireless transceiver connected to a microprocessor, the microprocessor being operable to receive a switch control signal from a remote location and further operable to alter a state of the switch in response to the switch control signal.

21. The monitoring unit of claim 16, wherein at least two of the decoding boards includes respective versions of a chipset.
